(19) United States
(12) Patent Application Publication
(10) Pub. No.: US 2015/0346505 A1
(43) Pub. Date: Dec. 3, 2015

(54) OPTICAL SYSTEM PROVIDING POLARIZED LIGHT

(71) Applicant: KONINKLIJKE PHILIPS N.V., Eindhoven (NL)

(72) Inventors: ADRIANUS JOHANNES STEPHANUS MARIA DE VAAN, 'S-HERTOGENBOSCH (NL); MARCO HAVERLAG, MIERLO (NL); BIANCA MARIA IRMA VAN DER ZANDE, HEEZE (NL)

(73) Assignee: KONINKLIJKE PHILIPS N.V., Eindhoven (NL)

(21) Appl. No.: 14/653,636

(22) PCT Filed: Apr. 30, 2014
(86) PCT No.: PCT/EP2014/058773

§ 371 Date: Jun. 18, 2015

(30) Foreign Application Priority Data
May 7, 2013 (EP) 13166749.5

(51) Int. Cl. G02B 27/28

(52) U.S. Cl. CPC G02B 27/28

(57) ABSTRACT

An optical system (100) is provided, having at least one light emitting module (110) adapted to emit light, and at least one reflector (120) arranged relatively to a corresponding one of the at least one light emitting module (110) so as to receive at least some light emitted by the at least one light emitting module (110). A polarizer (130) is provided so as to transmit light having at least a first polarization direction and to reflect light having at least a second polarization direction. The light emitting module (110) comprises at least one light emitting surface portion (114) and at least one corresponding reflective surface portion (112) which are arranged point symmetrically to each other with respect to a point (116) coinciding with an optical axis (A) of the at least one reflector (120) such that at least some of the light reflected by the polarizer (130) impinges on the reflective surface portion (112). The optical system (100) is capable of outputting polarized light at a relatively high efficiency.

### FIELD OF THE INVENTION

The present invention relates to an optical system with a partly reflective, partly transmissive polarizer and a light emitting module arranged to emit and reflect light. A method for providing such an optical system is also disclosed.

### BACKGROUND OF THE INVENTION

Illumination devices are known, wherein a polarizer is used for providing linearly polarized light. The polarizer is adapted to divide incident light into two linearly polarized components of opposite polarization characteristics. One of the components passes through the polarizer, while the other component is absorbed by the polarizer. One drawback with such a technique is however the relatively poor efficiency, due to the polarizer only transmitting one of the components.

In for example U.S. Pat. No. 3,566,099, this issue is addressed by providing a light projection assembly having a reflective-transmissive polarizer arranged over the mouth of a parabolic reflector, wherein one of the components passes through the polarizer and the other component is reflected back into the reflector. The reflected component, being oppositely polarized in relation to the transmitted component, is made to pass through a quarter-wave plate which is positioned directly behind the polarizer. The quarter-wave plate converts the reflected component into circularly polarized light, which is then reflected on the surface of the reflector and reversed into the opposite direction of polarization. As the reversed component passes back through the quarter-wave plate, it will emerge as light linearly polarized in the same direction as that of the original component transmitted by the polarizer and thus will pass through the polarizer reinforcing the transmitted component. There is however still a need for an optical system for generating polarized light having an improved efficiency.

US 2006/0238716 A1 discloses a light source module including a light emitting chip installed on a base to generate and emit illuminating light and having reflectivity to reflect light incident on the light emitting chip, a reflection mirror coupled with the base to reflect the light coming from the light emitting chip toward a front direction, and a polarization alignment unit installed on an exit end of the reflection mirror to feed back a portion of light incident on the polarization alignment unit by reflection and to polarize the light coming from the light emitting chip in one direction and output the polarized light, wherein the fed back light of the light incident on the polarization alignment unit is reflected back to the polarization alignment unit by at least one of the reflection mirror and the base.

US 2006/0196944 A1 discloses an LED light source formed of an LED and an angle control lens. The LED includes a LED chip on a substrate and is further provided with a reflection area arranged around the LED chip.

### SUMMARY OF THE INVENTION

In view of the above, an object of at least some of the embodiments of the present invention is to provide an optical system outputting polarized light having an improved efficiency.

Accordingly, an optical system and a method having the features of the independent claims are provided. The dependent claims define advantageous embodiments.

According to a first aspect of the invention, an optical system, or optical device, is provided, comprising at least one light emitting module adapted to emit light. The light emitting module comprises at least one light emitting surface portion and at least one corresponding reflective surface portion. Furthermore, the optical system comprises at least one reflector arranged relatively to a corresponding one of the at least one light emitting module so as to receive at least some light emitted by the at least one light emitting module, and a polarizer which is arranged relatively to the reflector so as to receive at least some of the light emitted by the at least one light emitting module. The polarizer is adapted to transmit light having at least a first polarization direction, and to reflect light having at least a second polarization direction. At least some of the reflected light is transmitted, for example via reflection at the reflector, back towards the at least one light emitting module. Each of the at least one light emitting surface portion and the at least one reflective surface portion is arranged asymmetrically with respect to an optical axis of the at least one reflector, and each of the at least one light emitting surface portion and the corresponding at least one reflective surface portion is arranged point symmetrically to each other with respect to a point coinciding with the optical axis of the at least one reflector. Thereby, at least some of the light reflected by the polarizer impinges on the at least one reflective surface portion, wherefrom at least some of the impinging light is reflected towards the polarizer, through which at least some of the impinging light is transmitted.

According to a second aspect of the present invention, a method for providing an optical system is provided. The method comprises providing at least one light emitting module adapted to emit light, wherein the light emitting module comprising at least one light emitting surface portion and at least one corresponding reflective surface portion. The method further comprises arranging at least one reflector relatively to a corresponding one of the at least one light emitting module so as to receive at least some light emitted by the at least one light emitting module, and arranging a polarizer relatively to the reflector so as to receive at least some of the light emitted by the at least one light emitting module. The polarizer is adapted to transmit light having at least a first polarization direction and to reflect light having at least a second polarization direction, wherein at least some of the reflected light is transmitted, for example via reflection at the reflector, back towards the at least one light emitting module. The step of providing at least one light emitting module comprises arranging each of the at least one light emitting surface portion and the at least one reflective surface portion asymmetrically with respect to an optical axis of the at least one reflector and arranging each of the at least one light emitting surface portion and the corresponding at least one reflective surface portion point symmetrically to each other with respect to a point coinciding with the optical axis of the at least one reflector such that at least some of the light reflected by the polarizer impinges on said at least one reflective surface portion. Thereby, at least some of the impinging light is reflected towards the polarizer, through which at least some of the impinging light is transmitted.

The present aspects are based on a realization that the amount of polarized light emitted from the optical system, or the efficiency of the optical system, is for example dependent on the degree or extent of light reflection within the reflector. By for example using a transmissive-reflective polarizer, which transmits light having a desired or required first direction of polarization and reflects at least some of the light that is not transmitted through the polarizer back into the reflector, an improved ‘recycling’ of the light generated by the light emitting module may be enabled. Further, by providing a light emitting module within the reflector, which e.g. may be circularly symmetric with respect to its optical axis, which light emitting module has a reflective surface portion and a light emitting surface portion which are arranged point symmetrically to each other with respect to a point coinciding with the optical axis and wherein the at least one light emitting surface portion and the at least one reflective surface portion are arranged asymmetrically with respect to the optical axis, the degree of light reflection within the reflector may be increased as compared to utilizing a light emitting module not having any reflective surface portion or not exhibiting such a point symmetric arrangement of the reflective surface portion relatively to the light emitting surface portion. The point symmetry of the optical system of the at least one reflective and light emitting surface portions and the asymmetric placement of the at least one reflective and light emitting surface portions with respect to the optical axis enables at least some of the light that is reflected back by the polarizer towards the light emitting module to impinge on the reflective surface portion arranged point symmetrically to the corresponding light emitting surface portion from which the light was emitted. Thereby, at least some of the light having the undesired, second polarization direction may be ‘recycled’ by means of the symmetrically arranged reflective surface portions of the light emitting module relatively to the light emitting surface portions, which are arranged asymmetrically with respect to the optical axis, and the efficiency of the optical system may hence be improved. By arranging the reflective surface portions such that at least some of the reflected light having the second polarization direction impinges on the reflective surface portion rather than on the light emitting surface portion of the light emitting module, the amount of light impinging on or absorbed by non-reflective surface portions of the light emitting module may advantageously be reduced. Since the polarization of the light, e.g. direction of polarization of the light, reflected by the polarizer may be changed upon reflection on a reflecting surface or surfaces, e.g. on the reflective surface portions of the light emitting module and/or on the reflector, at least some of the recycled light may eventually be transmitted through the polarizer as light having the desired direction of polarization.

It is generally known that point symmetry can also be described as a 180 degrees rotation in a plane around an axis. In this case, the at least one reflective surface portion and the at least one light emitting surface portion are arranged point symmetrically to each other with respect to a point coinciding with the optical axis can also be described as that the at least one reflective surface portion and the at least one light emitting surface portion are arranged 180 degrees rotated with respect to a point coinciding with the optical axis, or with respect to the optical axis, in the plane of the light emitting module.

The at least one light emitting surface portion is arranged asymmetrically with respect to the optical axis, which can also be described as that the at least one light emitting surface portion is not centered on or with respect to the optical axis. As the light emitting surface portion is arranged asymmetrically with respect to the optical axis, because of the mutual point symmetry with respect to the optical axis, also the reflective surface portion is arranged asymmetrically with respect to the optical axis, or, in other words, is also not centered on or with respect to the optical axis.

When comparing the relation, or fraction, between the area of the reflective surface portions and the area of the light emitting surface portions, it can be noted that the efficiency of the light recycling may increase with an increasing area of the reflective surface portions. The larger the area of the light-reflecting surface portions is in relation to the area of the light emitting surface portions, the larger is the probability of the reflected light impinging on a reflective surface portion. The present aspects are however advantageous in that a relatively high recycling efficiency may be obtained also for a relatively small total area covered by the light emitting surface portions and the reflective surface portions. This may be achieved by the symmetrical constitution of the reflective surface portions and the light emitting surface portions, wherein the reflective surface portions are arranged point symmetrically to the corresponding light emitting surface portions with respect to the optical axis. Thereby a relatively high amount of light reflection at the light emitting module may be obtained with a relatively small total area of reflective surface portions, which e.g. may cover an area equal to the area of the light emitting surface portions.

According to an embodiment, the polarizer is adapted so as to transmit and reflect light, respectively, having a first polarization state, such as e.g. linearly polarized light. The optical system may further comprise a polarizing state converter arranged relatively to the polarizer so as to receive at least some of the light reflected by the polarizer and to convert light having the first polarization state (being e.g. linearly polarized light) into light having a second polarization state, such as circularly or elliptically polarized light. The polarizing state converter is further arranged relatively to the reflector so as to receive at least some of the light reflected by the at least one reflective surface portion of the light emitting module, and to convert light having the second polarization state into light having the first polarization state. Allowing for at least some of the light reflected by the polarizer to be converted into circularly polarized light by the polarizing state converter advantageously enables for the direction of polarization to be changed from e.g. left-handed polarization to right-handed polarization, and vice versa, each time the circularly polarized light is reflected within the reflector, e.g. by the reflective surface portion of the light emitting module. Circularly polarized light that has been reflected an odd number of times on a reflecting surface or surfaces, e.g. on a reflective surface portion of the light emitting module and/or on the reflector, before it returns to the polarizing state converter may have a reversed direction of polarization, while circularly polarized light that has been reflected an even number of times within the reflector upon returning to the polarizing state converter may have the same direction of polarization as when it left the polarizing state converter. Polarized light having a reversed direction of polarization may advantageously be converted by the polarization state converter into linearly polarized light having the second direction of polarization, which may be transmitted through the polarizer. Thereby the amount of transmitted light, and hence the efficiency of the optical system, may be increased.

According to an embodiment, the polarizer is adapted so as to transmit and reflect light, respectively, having a first polarization state, such as e.g. circularly polarized light. The polarizer may for example be configured such as the polarizers disclosed in EP0606940 B1 or EP0606939 B1. The optical system may further comprise a polarizing state converter being arranged relatively to the polarizer so as to receive at least some of the (e.g., circularly polarized) light transmitted by the polarizer, and to convert light having the first polarization state into light having a second polarization state, such as e.g. linearly polarized light. The present embodiment thereby allows for the polarizer, or reflective-transmissive polarizer, to transmit circularly, or elliptically, polarized light having a desired or required first direction of polarization, and to reflect at least some circularly polarized light having a second direction of polarization. As previously described, the reflected circularly polarized light may reverse its direction of polarization upon an odd number of reflections on a reflecting surface or surfaces, e.g. on a reflective surface portion of the light emitting module and/or on the reflector, such that light having e.g. the second direction of polarization may be converted into light having the first direction of polarization, and vice versa. Hence, at least some of the recycled light that reaches the polarizer comprises circularly, or elliptically, polarized light having the desired or required first direction of polarization. The reflector and/or the reflective surface portion of the light emitting module may be used as a converter for converting light reflected by the polarizer into light having the desired or required direction of polarization, which light thereby may be transmitted through the polarizer.

According to an embodiment, the polarizing state converter comprises a plurality of stacked birefringent layers. Using such a polarizing state converter may allow for compensating for or reducing the extent of any ellipticity which may be introduced in the polarization of light during reflection in the reflector. The stacked birefringent layers may further allow for an achromatic polarizing state converter to be obtained.

Additionally, or alternatively, the polarizing state converter may comprise a twisted liquid crystalline structure, e.g. a 90° twisted nematic liquid crystalline structure, which e.g. may include a liquid crystalline layer sandwiched between two transparent substrates, or a polymerized liquid crystalline material.

By arranging the light emitting module at various positions along the optical axis of the optical system, or the reflector, the angle and shape of the light beam exiting the optical system may be adjusted. According to one example, the at least one light emitting module may be arranged in a plane orthogonal to the optical axis of the at least one reflector, which optical axis intersects the at least one light emitting module. According to another example, the at least one light emitting module is arranged such that a focal point of the corresponding one of the at least one reflector coincides with the at least one light emitting module. For example in case the reflector comprises a parabolic reflector, by arranging the light emitting module such that a focal point of the parabolic reflector coincides with the light emitting module, an essentially collimated light beam may be generated.

According to an embodiment, the at least one light emitting surface comprises a light emitting diode (LED) arranged on at least a portion of a printed circuit board. However, this is merely a non-limiting example of a light emitting surface. In the context of the present application, the term “light emitting surface” is used to define a light emitting surface of a light source that can be substantially any device or element that is capable of emitting radiation in any region or combination of regions of the electromagnetic spectrum, for example the visible region, the infrared region, and/or the ultraviolet region, when activated e.g. by applying a potential difference across it or passing a current through it. Therefore a light source can have monochromatic, quasi-monochromatic, polychromatic or broadband spectral emission characteristics. Examples of light sources include semiconductor, organic, or polymer/polymeric LEDs, lasers, blue LEDs, RGB LEDs, optically pumped phosphor coated LEDs, optically pumped nano-crystal LEDs, RGB lasers, laser pumped phosphor(s), or any other similar devices as known to a person skilled in the art.

According to an embodiment, the at least one reflective surface portion comprises a mirror coating or the like which may be non-conducting and/or electrically isolated from the at least one light emitting surface portion. A non-conducting coating may be directly applied on the surface of the light emitting module without risking short-circuiting any electrically conducting pathways. An electrically conducing mirror coating may be used if electrically isolated from the surface portion, so as to reduce the risk for short-circuiting of the conducting pathways.

According to an embodiment, the optical system comprises a plurality of light emitting modules and/or a plurality of reflectors. By providing a plurality of reflectors, each of which corresponding to at least one light emitting module, a light beam having a relatively large cross section may be obtained with an optical system being relatively flat as compared with an optical system having several light emitting modules and a single reflector. Due to the width of e.g. a parabolic or spherical reflector being dependent on the depth of the reflector, as measured along the optical axis of the reflector, a relatively wide reflector may correspond to a relatively deep reflector. Using a plurality of reflectors may hence allow for achieving an optical system with a plurality of light emitting modules which is relatively wide and at the same time relatively flat.

According to an embodiment, the optical system comprises at least one refractive lens adapted to collect most or all of, or at least a portion of the light transmitted through the polarizer and to form or shape the light into a selected or desired beam shape. The at least one lens may for example be arranged to focus and/or direct light transmitted through the polarizer onto an illuminated target or object. Thereby the illumination by means of the optical system may e.g. be adapted to the distance between the optical system and the illuminated target or object. The optical system may comprise several lenses which may be controllably movable in relation the light emitting module, preferably towards and/or away from the light emitting module, which enables the focus of the light beam output from the optical system to be adjusted. Examples of lenses include spherical, aspherical, biconvex, plano-convex, biconcave, plano-concave lenses, or Fresnel lenses.

According to an embodiment, the polarizer is adjustably arranged relatively to the reflector, or vice versa, so as to allow for the direction of polarization of the light transmitted through the polarizer to be adjusted. The possibility of adjustment of the direction of polarization of the light transmitted through the polarizer may e.g. be realized by means of the polarizer being rotatably arranged so as to be able to rotate about the optical axis of the reflector.

The optical system may comprise an indicator adapted to indicate the direction of polarization of the light transmitted through the polarizer. The indicator may be arranged such as to provide guidance for a user how to adjust the arrangement of the polarizer relatively to the reflector, or vice versa, such that the direction of polarization of the light transmitted through the polarizer becomes closer to or equal to a selected direction of polarization of the light transmitted through the polarizer.

The user may for example be viewing or looking at an at least partly reflective surface of a target or object illuminated by the optical system. By providing guidance for a user how to adjust the direction of polarization of light illuminating the surface of the target or object, the amount or extent of reflections of light from the surface reaching the eye of the user or observer may be controlled (by the user) so as to comply with a desired or selected criterion. This may be achieved by making use of the observation that the fraction of incident light that is reflected at the surface inter alia depends on the direction of polarization of the incident light. Thus, by adjusting the direction of polarization of the light transmitted through the polarizer and impinging on the surface the extent of light reflection at the surface may be controlled or adjusted. The direction of polarization of the light transmitted through the polarizer may for example be controlled such that e.g. s-polarized light (i.e. light having a direction of polarization orthogonal to the plane of incidence) or p-polarized light (i.e. having a direction of polarization parallel to the plane of incidence) impinges on the surface of the illuminated target or object. The s-polarized light may advantageously allow for a relatively high extent of light reflection from the at least partially reflective surface of the illuminated target or object, whereas the p-polarized light may allow for a relatively low extent of light reflection from the at least partially reflective surface of the illuminated target or object. Being able to adjust the direction of polarization of the light transmitted through the polarizer may enable a relatively flexible optical system that can be adapted by e.g. a user or observer so as to reduce or increase the reflections at the illuminated target or object.

Being able to reduce the extent of light reflection, or glare, from the surface being viewed by the user or observer may allow for reducing disturbing glare from information carriers such as glossy magazines and electronic tablets, and hence improve the readability of text or the like on the information carrier. By the observer or user being able to reduce undesired glare from such surfaces, it may be possible for e.g. publishers and manufacturers of flat screen products to use paper and displays having a glossy finish. Being able to adjust the direction of polarization of the light impinging on an object so as to increase the amount of reflected light may be advantageous for illumination of crystals, jewels, diamonds, and other objects wherein a sparkling effect is desired. Reflections may also be desired at glossy surfaces for design purposes. The present embodiment may also provide a relatively flexible optical system which can be adapted to various illumination conditions and requirements. As previously mentioned, the optical system may be used for example both for providing enhanced sparkling effects in crystals and for providing comfortable illumination for reading of a glossy magazine.

An indicator should, in the context of the present application, be understood as any means arranged for indicating e.g. to the user a direction of polarization of light exiting the optical system. The indicator may for example be realized by pointer or a marking, such as an arrow, text, symbol, or picture, and may indicate the direction of the polarization of the exiting light, or the required direction or orientation of the polarizer at which a desired illumination may be achieved. The desired illumination may e.g. be defined by the desired or selected criterion for extent of light reflection from the surface at illuminated target or object. In alternative or in addition, the indicator may be auditory or tactile, or any combination of visual, auditory and tactile.

It is noted that the invention relates to all possible combinations of features recited in the claims.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, in which:

FIG. 1 schematically depicts a cross sectional side view of an optical system according to an embodiment of the present invention, comprising a light emitting module and a transmissive-reflective polarizer;

FIG. 2 schematically depicts a cross sectional side view of an optical system according to another embodiment of the present invention;

FIGS. 3a-3d each schematically depicts a top or frontal view of a light emitting module having at least one light emitting surface portion with a corresponding reflective surface portion;

FIG. 4 schematically a cross sectional side view of an optical system according to an embodiment of the present invention, comprising a plurality of reflectors and light emitting modules; and

FIG. 5 schematically depicts an optical system according to an embodiment of the present invention.

All the figures are schematic, not necessarily to scale, and generally only show parts which are necessary in order to elucidate the invention, wherein other parts may be omitted or merely suggested.

### DETAILED DESCRIPTION

The present invention will now be described hereinafter with reference to the accompanying drawings, in which exemplifying embodiments of the invention are shown. This invention may, however, be embodied in many different forms and should not be construed as limited to the embodiments set forth herein; rather, these embodiments are provided for thoroughness and completeness, and to convey the scope of the invention to the skilled person.

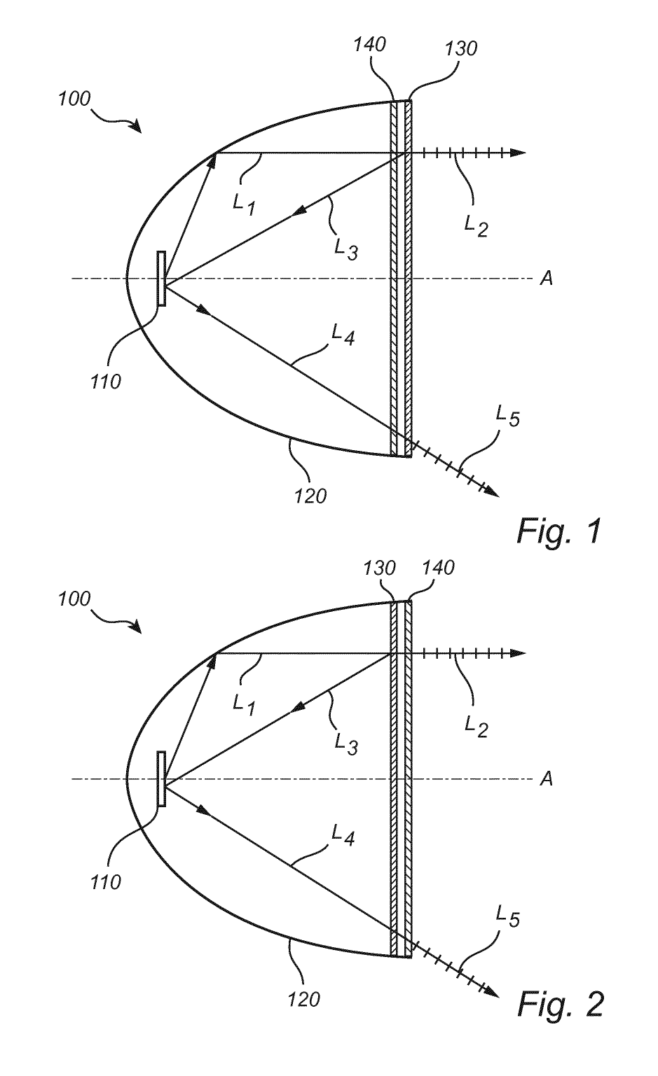

With reference to FIG. 1, there is shown a cross sectional side view of an optical system 100 according to an embodiment of the present invention. The optical system 100 comprises a reflector 120, such as a parabolic reflector 120 in accordance with the present embodiment, within which a light emitting module 110 is arranged to emit light. A polarizing state converter 140, such as e.g. a quarter-wave plate 140, is arranged relatively to the reflector 120 so as to receive at least some of the light L₁ emitted by the light emitting module 110. The optical system 100 also comprises a polarizer, such as e.g. a reflective-transmissive linear polarizer 130, which is arranged relatively to the polarizing state converter 140 so as to receive at least some of the light transmitted by or transmitted through the polarizing state converter 140. The polarizer 130 is adapted to transmit light L₂ having a selected polarization direction, such as e.g. linearly polarized light having a polarization direction parallel to the plane of incidence on the polarizer 130, and to reflect light having another polarization direction, such as e.g. linearly polarized light having a polarization direction orthogonal to the plane of incidence.

Thus, according to the depicted embodiment, the polarizer 130 is adapted so as to transmit and reflect, respectively, light having a first polarization state, e.g. linearly polarized light. The polarizing state converter 140 is arranged relatively to the polarizer 130 so as to receive at least some of the light reflected by the polarizer 130 and to convert light having the first polarization state into light having a second polarization state, e.g. circularly polarized light.

The polarizing state converter 140 or quarter-wave plate 140 may further be arranged to receive polarized light reflected at the polarizer 130 and convert at least some of the light into light having the second polarization state, e.g. circularly polarized light L₃, which is transmitted back towards the reflector 120 or the light emitting module 110. Every time the circularly polarized light L₃ is reflected on a reflecting surface, e.g. on a reflective surface portion 112 of the light emitting module 110 and/or on the reflector 120, the direction of polarization of the light is changed such that e.g. right handed polarized light is converted into left handed polarized light, and vice versa. Therefore, at least some of the light L₄ that has been reflected an odd number of times and when it eventually impinges on the quarter-wave plate 140, may be converted by the quarter-wave plate 140 into linearly polarized light L₅ having the selected direction of polarization, and may thus be transmitted by (through) the polarizer 130.

According to the embodiment depicted in FIG. 1, the light emitting module 110 is arranged in a plane orthogonal to the optical axis A of the reflector 120, which optical axis A intersects the light emitting module 110 in a point P (not shown). Further, the light emitting module 110 may be arranged such that a focal point of the reflector 120 coincides or substantially coincides with the light emitting module 110.

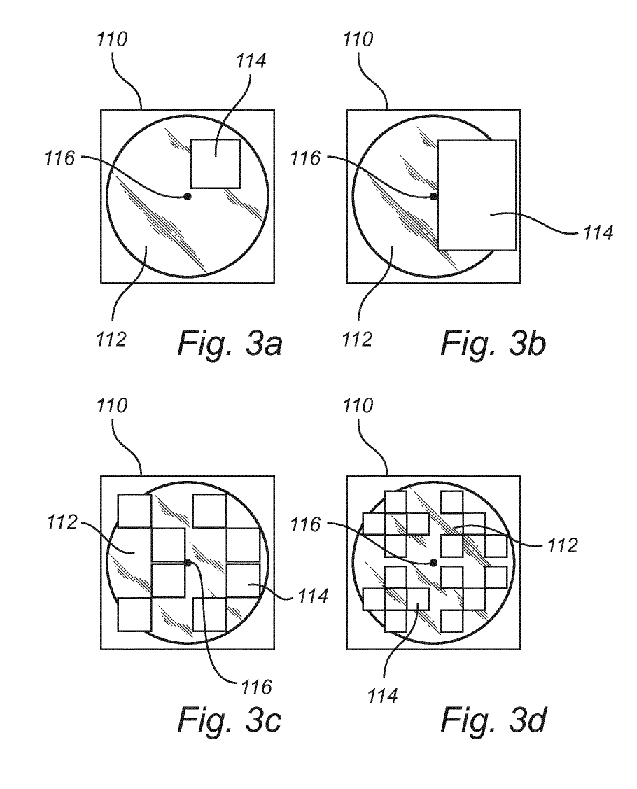

As will be described in more detail with reference to FIGS. 3a-3d, the light emitting module 110 comprises at least one light emitting surface portion 114 having a corresponding reflective surface portion 112 being point symmetrically arranged with respect to a point 116 in which the optical axis A intersects the light emitting module 110. The at least one light emitting surface portion 114 and the at least one reflective surface portion 112 are both arranged asymmetrically with respect to the optical axis A, i.e. both surface portions are not centered on or with respect to the optical axis A. Also the at least one light emitting surface portion 114 and the corresponding reflective surface portion 112 are arranged point symmetrically with respect to the point 116 such that at least some of the light reflected by the polarizer 130 impinges on the at least one reflective surface portion 112. At least some of the light impinging on the at least one reflective surface portion 112 is reflected towards the polarizer 130, through which at least some of the light then can be transmitted.

According to the embodiment depicted in FIG. 1, the polarizing state converter 140 is arranged relatively to the reflector 120 so as to receive at least some of the light reflected by the at least one reflective surface portion 112 and to convert light having the second polarization state into light having the first polarization state.

FIG. 2 depicts an optical system 100 similar to the optical system 100 as described with reference to FIG. 1. The optical system 100 depicted in FIG. 2 differs from the optical system 100 depicted in FIG. 1 in the arrangement of the polarizer 130 and the polarizing state converter 140 relatively to each other. In the optical system 100 depicted in FIG. 2, the polarizer 130 comprises or is a reflective-transmissive circular polarizer 130 arranged to transmit e.g. circularly polarized light, having a selected direction of polarization, such as e.g. right-handed polarization, and to reflect e.g. circularly polarized light L₃ having another direction of polarization, such as e.g. left-handed polarization. According to the embodiment depicted in FIG. 2, the polarizing state converter 140, which e.g. may comprise or be a quarter-wave plate, is arranged relatively to the polarizer 130 so as to receive at least some of the transmitted circularly polarized light and to convert at least some of the transmitted light L₅ into linearly polarized light.

Thus, the polarizer 130 is adapted so as to transmit and reflect light, respectively, having a first polarization state, e.g. circularly polarized light, and the polarizing state converter 140 is arranged relatively to the polarizer 130 so as to receive at least some of the light transmitted by the polarizer 130, and to convert light having the first polarization state into light having a second polarization state, e.g. linearly polarized light.

FIGS. 3a-3d schematically illustrate light emitting modules 110 according to embodiments of the present invention, comprising light emitting surface portions 114 and corresponding reflective surface portions 112. According to the depicted embodiments, each of the light emitting surface portions 114 and the reflective surface portion 112 are arranged asymmetrically, or in other words not centered, with respect to the optical axis A of the reflector 120 (not shown in FIGS. 3a-3d) and each of the light emitting surface portions 114 has a respective corresponding reflective surface portion 112 arranged point symmetrically with respect to a point 116 coinciding with the optical axis A of the reflector 120. Due to the point symmetry of the optical system 100, at least some of the light that is emitted from a light emitting surface portion 114 and reflected by the polarizer 130 (not shown in FIGS. 3a-3d) impinges on the corresponding reflective surface portion 112, wherefrom at least some of the impinging light is reflected towards the polarizer 130.

In FIGS. 3a and 3b, there are shown light emitting modules 110 according to embodiments of the invention, each of which light emitting modules 110 comprising a LED 114 arranged on a PCB, and a corresponding reflective surface portion 112, which may be provided with a mirror coating. The reflective surface portion 112 is arranged point symmetrically with respect to a point 116 coinciding with the optical axis of the reflector 120 (not shown in FIGS. 3a and 3b), such that at least some of the emitted light that is reflected by the polarizer 130 (not shown in FIGS. 3a-3d) impinges on the corresponding reflective surface portion 112.

FIGS. 3c and 3d show further examples of light emitting modules 110 according to embodiments of the invention, each of which light emitting modules 110 comprising a plurality of light emitting surface portions 114 and wherein each one of the plurality of light emitting surface portions 114 and the reflective surface portions 112 is arranged asymmetrically, or in other words not centered, with respect to the optical axis A of the reflector 120 (not shown in FIGS. 3c and 3d) and each one of the plurality of light emitting surface portions 114 has a corresponding reflective surface portion 112 arranged point symmetrically with respect to the point 116, defined by the intersection of the optical axis A of the reflector 120 and the light emitting module 110.

In general, the light emitting surface portions 114 may for example be arranged so as to cover up to 50% of the surface of the light emitting module 110. Further, the light emitting surface portions 114 and the corresponding reflective surface portions 112 may be arranged to conform with a circular shape or the shape of a circular disc (indicated by a circular line in FIGS. 3a-d), which may allow for providing a light beam emitted by the optical system 100 having an essentially circular cross section.

Even though the light emitting surface portions 114 for illustrative purposes are depicted as squares in FIGS. 3a-d, it will be appreciated that the light emitting surface portions may have for example a circular or elliptic shape, or any other suitable shape.

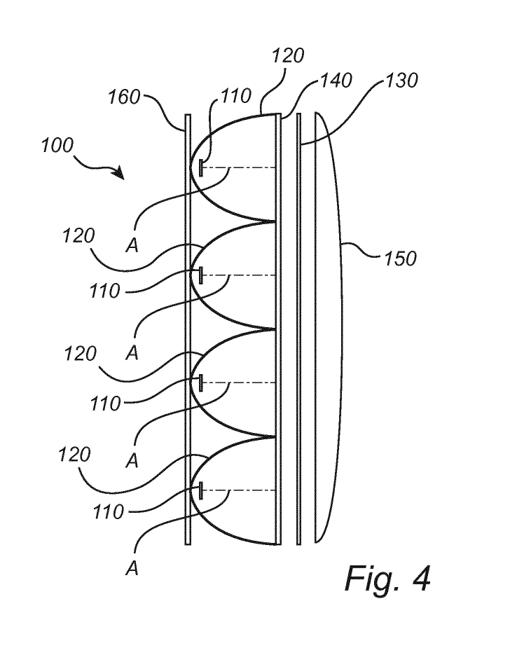

FIG. 4 is a cross sectional side view of an optical system 100 according to an embodiment of the present invention, comprising a plurality of reflectors 120 arranged on a common substrate such as a printed circuit board (PCB) 160. However, it is possible to arrange each reflector 120 on a separate substrate, or subsets of reflectors 120 on separate substrates (e.g. PCBs). The reflectors 120 may for example comprise or be parabolic reflectors. Within each reflector 120 there is provided a respective or corresponding light emitting module 110, having at least one light emitting surface portion 114 and at least one corresponding reflective surface portion 112 which are arranged asymmetrically with respect to the optical axis A of the respective reflector 120 and which are arranged point symmetrically with respect to a point 116 coinciding with the optical axis A of the respective reflector 120. The light emitting modules are arranged so as to emit light towards a polarizing state converter 140 and a polarizer 130, such as e.g. a reflective-transmissive linear polarizer 130, similar to or the same as the polarizing state converter 140 and the polarizer 130 in the illumination device 100 described above with reference to FIG. 1. The polarizing state converter 140 and the polarizer 130 may form a unit which is adjustable, e.g. rotatable, in relation to the plurality of reflectors 120 and the plurality of light emitting modules 110, so as to enable the direction of polarization of the generated polarized light output by the optical system 100 to be adjusted. Further, in accordance with the depicted embodiment a refractive lens 150 can be arranged to receive or collect most or even all of the light transmitted through the polarizer 130 and to form or shape the light into a desired beam shape. The lens 150 can be arranged to be controllably movable in a direction towards and/or away from the light emitting module 110 such that the focus of the exiting light beam can be adjusted.

A lens 150 such as described above can be implemented in any one of the embodiments of the present invention described herein. If implemented in the embodiment described with reference to FIG. 2, the lens 150 may be arranged so as to receive most or all, or at least a portion, of the light transmitted through the polarizing state converter 140. As indicated in FIG. 4, the plurality of reflectors 120 and light emitting modules 110 may be arranged abreast of each other (side by side) so as to form e.g. a row or a matrix.

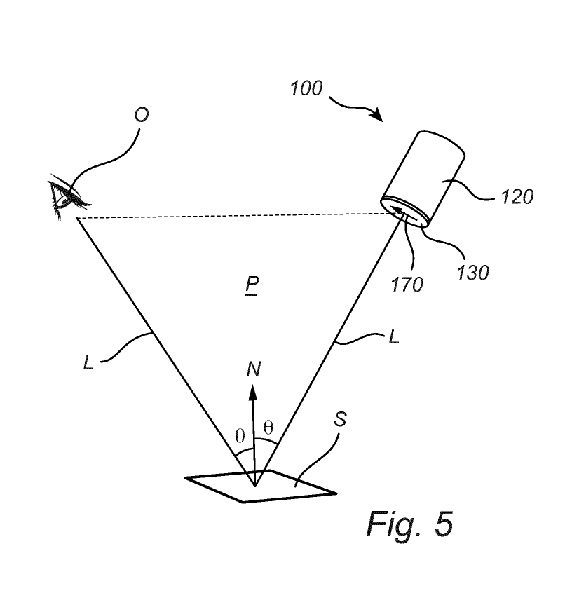

With reference to FIG. 5, there is schematically depicted an optical system 100 according to an embodiment of the invention. The optical system 100 comprises a reflector 120 having a light emitting module (not shown in FIG. 5) with an at least one light emitting surface portion and at least one corresponding reflective surface portion arranged asymmetrically with respect to the optical axis A (not shown in FIG. 5) of the reflector 120 and arranged point symmetrically with respect to a point 116 coinciding with the optical axis A of the reflector 120. A polarizer 130 is arranged to receive at least some of the light output from the reflector 120, and is provided with an indicator 170 for example in the form of an arrow 170. The direction of polarization of light emitted by the optical system 100 may e.g. be adjusted by rotating the polarizer 130 about the optical axis A (not shown) of the reflector 120. The adjustment may in alternative or optionally be realized by a rotation of the entire optical system 100 about the optical axis A. The optical system 100 may be arranged such that polarized light exiting the polarizer 130 impinges on a surface S being viewable by an observer or user O. The indicator 170 may be arranged so as to indicate to the observer O the direction of the polarization of the light emitted by the optical system 100. The surface S may, according to the present embodiment, be at least partially reflective and realized by e.g. a piece of paper having a glossy finish. The path of the light, being represented by the lines L in FIG. 5, extends in a plane of incidence P. The plane of incidence P may be defined by a gaze point of the observer O, the point of incidence of the light on the surface S, and a position of the polarizer 130 (e.g. by a point on the polarizer 130 from which the light L is emitted). The indicator 170, e.g. arrow 170, may be arranged so as to provide guidance for the observer O how to adjust the direction of polarization of light illuminating the surface S such that the extent of light reflection e.g. is reduced. By adjusting the polarizer 130 such that the arrow 170 is pointing towards the observer O, the light emitted from the polarizer 130 may be p-polarized, i.e. having a direction of polarization being parallel with the plane of incidence P, which thereby enables a reduced amount of reflected light from the surface S. Accordingly, by rotating the arrow 170, and hence the polarizer 130, by about 90° or by 90° in either direction, the light emitted from the polarizer 130 may be s-polarized, i.e. having a direction of polarization that is orthogonal to the plane of incidence P. Thereby, the extent of light reflection at the surface S may be increased.

Additionally, or alternatively, the extent of light reflection at the surface S may be adjusted by varying the angle of incidence θ at the surface S, which can be defined by the angle between the direction of the incident light and the normal N to the surface S. By e.g. illuminating the surface S with p-polarized light at an angle of incidence equal or at least close to the Brewster angle of the surface S, a reduced or minimum of reflectance of the light from the surface S may be achieved.

The person skilled in the art realizes that the present invention by no means is limited to the preferred embodiments described above.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. An optical system comprising:
at least one light emitting module adapted to emit light, the light emitting module comprising at least one light emitting surface portion and at least one corresponding reflective surface portion;
at least one reflector arranged relatively to a corresponding one of the at least one light emitting module so as to receive at least some light emitted by the at least one light emitting module;
a polarizer arranged relatively to the reflector so as to receive at least some of the light emitted by the at least one light emitting module, the polarizer being adapted to transmit light having at least a first polarization direction and to reflect light having at least a second polarization direction, wherein at least some of the reflected light is transmitted back towards the at least one light emitting module;
wherein each of the at least one light emitting surface portion and the at least one reflective surface portion are arranged asymmetrically with respect to an optical axis (A) of the at least one reflector and wherein each of the at least one light emitting surface portion and the corresponding at least one reflective surface portion are arranged point symmetrically to each other with respect to a point coinciding with the optical axis (A) of the at least one reflector such that at least some of the light reflected by the polarizer impinges on said at least one reflective surface portion, wherefrom at least some of the impinging light is reflected towards the polarizer, through which at least some of the said impinging light is transmitted.

2. The optical system according to claim 1, wherein the polarizer is adapted so as to transmit and reflect light, respectively, having a first polarization state, the optical system further comprising:
a polarizing state converter being arranged relatively to the polarizer so as to receive at least some of the light reflected by the polarizer and to convert light having the first polarization state into light having a second polarization state;
the polarizing state converter further being arranged relatively to the reflector so as to receive at least some of the light reflected by the at least one reflective surface portion and to convert light having the second polarization state into light having the first polarization state.

3. The optical system according to claim 1, wherein the polarizer is adapted so as to transmit and reflect light, respectively, having a first polarization state, the optical system further comprising:
a polarizing state converter being arranged relatively to the polarizer so as to receive at least some of the light transmitted by the polarizer and to convert light having the first polarization state into light having a second polarization state.

4. The optical system according to claim 2, wherein the polarizing state converter comprises a plurality of stacked birefringent layers.

5. The optical system according to claim 2, wherein the polarizing state converter comprises a twisted liquid crystalline structure.

6. The optical system according to claim 1, wherein the at least one light emitting module is arranged in a plane orthogonal to the optical axis of the at least one reflector, which optical axis intersects the at least one light emitting module.

7. The optical system according to claim 1, wherein the at least one light emitting module is arranged such that a focal point of the corresponding one of the at least one reflector coincides with the at least one light emitting module.

8. The optical system according to claim 1, wherein the reflector comprises a parabolic reflector.

9. The optical system according to claim 1, wherein the at least one light emitting surface comprises a light emitting diode arranged on at least a portion of a printed circuit board.

10. The optical system according to claim 1, wherein the at least one reflective surface portion comprises a mirror coating which is non-conducting or electrically isolated from the at least one light emitting surface portion.

11. The optical system according to claim 1, wherein the optical system comprises a plurality of light emitting modules and a plurality of reflectors.

12. The optical system according to claim 1, further comprising a lens arranged to receive the light transmitted through the polarizer and to form the light into a selected beam shape.

13. The optical system according to claim 1, wherein the polarizer is adjustably arranged relatively to the reflector, or vice versa, so as to allow for the direction of polarization of the light transmitted through the polarizer to be adjusted.

14. The optical system according to claim 13, further comprising an indicator adapted to indicate the direction of polarization of the light transmitted through the polarizer, the indicator being arranged such as to provide guidance for a user how to adjust the arrangement of the polarizer relatively to the reflector, or vice versa, such that the direction of polarization of the light transmitted through the polarizer becomes closer to or equal to a selected direction of polarization of the light transmitted through the polarizer.

15. A method for providing an optical system, the method comprising:
providing at least one light emitting module adapted to emit light, the light emitting module comprising at least one light emitting surface portion and at least one corresponding reflective surface portion;
arranging at least one reflector relatively to a corresponding one of the at least one light emitting module so as to receive at least some light emitted by the at least one light emitting module; and
arranging a polarizer relatively to the reflector so as to receive at least some of the light emitted by the at least one light emitting module, the polarizer being adapted to transmit light having at least a first polarization direction and to reflect light having at least a second polarization direction, wherein at least some of the reflected light is transmitted back towards the at least one light emitting module;
wherein the provision of the at least one light emitting module comprises arranging each of the at least one reflective surface portion and the at least one reflective surface portion asymmetrically with respect to an optical axis of the at least one reflector and arranging each of the at least one reflective surface portion and the corresponding at least one reflective surface portion point symmetrically to each other with respect to a point coinciding with the optical axis of the at least one reflector such that at least some of the light reflected by the polarizer impinges on said at least one reflective surface portion, wherefrom at least some of the impinging light is reflected towards the polarizer, through which at least some of the said impinging light is transmitted.
